(19) United States
(12) Patent Application Publication
(10) Pub. No.: US 2014/0074469 A1
(43) Pub. Date: Mar. 13, 2014

(54) Apparatus and Method for Generating Signatures of Acoustic Signal and Apparatus for Acoustic Signal Identification

(71) Applicant: Sergey Zhidkov, Izhevsk (RU)

(72) Inventor: Sergey Zhidkov, Izhevsk (RU)

(21) Appl. No.: 14/020,844

(22) Filed: Sep. 8, 2013

Related U.S. Application Data
(60) Provisional application No. 61/699,394, filed on Sep. 11, 2012.

(51) Int. Cl. G10L 15/08

(52) U.S. Cl. CPC G10L 15/08
USPC 704/236

(57) ABSTRACT

Method and apparatus for generating compact signatures of acoustic signal are disclosed. A method of generating acoustic signal signatures comprises the steps of dividing input signal into multiple frames, computing Fourier transform of each frame, computing difference between non-negative Fourier transform output values for the current frame and non-negative Fourier transform output values for one of previous frames, combining difference values into subgroups, accumulating difference values within a subgroup, combining accumulated subgroup values into groups, and finding an extreme value within each group.

### CROSS-REFERENCE TO RELATED APPLICATIONS

This application claims the benefit of U.S. Provisional Application No. 61/699,394, filed Sep. 11, 2012.

### BACKGROUND OF THE INVENTION

The problem of comparing and matching acoustic signals arises in several applications, such as monitoring and identification of music aired on TV or radio broadcasting channels. measuring TV/radio audience, linking online content to a particular audio signals and in some other applications.

Matching of acoustic signals can be performed via methods of correlation analysis. For example, such approach has been proposed in U.S. Pat. No. 3,919,479 and No. 4,450,531. However, these methods have several drawbacks:

Firstly, computing correlation of two or more digitized acoustic signals computationally is very CPU intensive.

Secondly, two acoustic signals, which sound almost identically for human ear, may differ significantly by sound waveforms, because of psychoacoustic properties of human hearing system (insensitivity of human hearing to phase distortions and time-frequency masking effect, etc.)

Thirdly, in most applications, where the comparison of multiple acoustic signals is needed, the amount of memory required to store the original audio samples can be excessively large.

To overcome abovementioned drawbacks, one can utilize a method of acoustic signatures (aka, audio fingerprinting). An acoustic signature of audio fragment is a compact set of numerical values, which represents the major psychoacoustic properties of considered fragment. After computation of acoustic signatures the audio fragments can be compared by comparing their corresponding signatures.

A good audio signature generation method has the following desirable properties:
It should be insensitive to small audio distortions and transformations (e.g. lossy compression, filtering and so on), that may occur during audio signal distribution via analog or digital media channels
It should be compact to allow storing large arrays of signatures and simplify signature comparisons
It should allow simple generation and cross comparison of signatures with minimal microprocessor usage, which is especially important in mobile applications where the microprocessor capabilities are usually limited

For example, U.S. Pat. No. 7,549,052 discloses a prior art method of deriving a signature from audio signals, which includes the following steps (see also FIG. 1):
Dividing audio signal fragment into multiple overlapped frames
Calculating Fourier Transform of the frame
Calculating signal energy values for multiple frequency bands E(n,m), where n is the frame index, and m is the frequency band index, m=1, . . . M.
Calculating binary signature value in accordance with simple equation:

$$H ( n , m ) = \{ \begin{matrix}1 , if ( E ( n , m ) - E ( n , m + 1 ) ) - ( E ( n - 1 , m ) - E ( n - 1 , m + 1 ) ) > 0 \\ 0 , if ( E ( n , m ) - E ( n , m + 1 ) ) - ( E ( n - 1 , m ) - E ( n - 1 , m + 1 ) ) \leq 0\end{matrix}$$

Generally, this method demonstrates good performance in real-life applications. Nonetheless. it has several drawbacks and limitations:
Signature size: as suggested in U.S. Pat. No. 7,549,052 and in accordance with our own experiments to achieve robust performance using this prior art method it is necessary to use, at least, 32-bit signature per frame. If the frame interval is equal to 12 ms then the resulting acoustic signature stream is 344 Bytes per second,
Microprocessor intensive direct signature comparison: In particular, the prior art method requires bit-by bit comparison of 32-bit signature words. However, in many mobile CPUs (such as ARM) there is no dedicated hardware instruction to perform such comparison, therefore, counting bit matching should be performed via software procedure, which requires multiple CPU cycles (for example, in ARM microprocessor this requires at least 10 CPU cycles per word).

In the present invention, we propose a new method of generating acoustic signatures, which allows minimizing audio-signature size and reduces CPU resources required for direct signature comparison. Meanwhile, in comparison with known prior art methods, the proposed method demonstrates the same or higher probability of correct detection of noisy and distorted acoustic fragments.

### BRIEF SUMMARY OF THE INVENTION

In the proposed method, to generate a compact signature of acoustic signal one should perform the following consecutive steps:
(1) Firstly, the digitized sound signal shall be divided into (overlapped) frames.
(2) Then (optionally) for each frame the smoothing window function (e.g. Hann window) shall be applied
(3) After that, the Fourier transform (FT) for the current frame shall be computed and the output samples shall be squared.
(4) Then, from each squared FT output value for the current frame the corresponding value for the previous frame shall be subtracted as D(n,k)=X(n,k)=X(n−l,k) where X(n,k) is a squared output of k-th Fourier transform bin for n-th frame.
(5) After that, the differences D(n,k) shall be divided into M groups (m=1,2, . . . ,M) with l subgroups in each group; where each subgroup consists of fixed number (Pₘ) of difference samples D(n,k).
(6) Values of D(n,k), corresponding to each subgroup shall be accumulated, such that for each group one obtains a set of accumulated values S(n,m,i)
(7) Finally, inside each group m=1,2, . . . , M a subgroup with maximum value of S(n,m,i) shall be found such that

$${i}_{m}^{( max )} = {max}_{i} S ( n , m , i )$$

Here, the set of indexes iₘ^{(max)}, m=1, 2, . . . , M is referred to as an acoustic signature of current sound frame.

The acoustic signature of sound fragment corresponds to the sequence of frame signatures, i.e.: {i₁^{(max)}(n), . . . , i_{M}^{(max)}}, {i₁^{(max)}(n+1), . . . , i_{M}^{(max)}(n+1)}, {i₁^{(max)}(n+2), . . . , i_{M}^{(max)}(n+2)}, . . .

The comparison and search of audio signatures can be implemented by comparing max. indexes {i₁^{(max)}(n), . . . , i_{M}^{(max)}}, {i₁^{(max)}(n+1), . . . , i_{M}^{(max)}(n+1)}, {i₁^{(max)}(n+2), . . . , i_{M}^{(max)}(n+2)}, . . . of two or more acoustic fragments. During comparison process only a simple fact of matching/not-matching of corresponding indexes iₘ^{(max)}(n) shall be detected, and the total number of matching indexes shall be counted. In case of perfect matching of audio fragments composed of N frames, the number of matching acoustic signature indexes shall be N×M. In case of comparing random (uncorrelated) acoustic fragments, an average number of matching indexes shall be approximately: (N×M)/I. Thus, the optimal decision threshold shall be in the range of (N×M)/I . . . N×M, and shall depend upon application requirements for the trade-off between probability of false identification and probability of misdetection of correct signal.

### BRIEF DESCRIPTION OF THE DRAWINGS

FIG. 1 shows schematically a prior art circuit arrangement for extracting a signature from acoustic signal

FIG. 2 shows an arrangement for generating a signature from the acoustic signal in accordance with the present invention.

FIG. 3 illustrates the principle of grouping Fourier transform bins into subgroups and groups in accordance with the present invention.

FIG. 4 shows an exemplary embodiment of acoustic signal identification apparatus in accordance with the present invention

FIG. 5 illustrates identification of reference signature sample in noisy acoustic signal by prior art method and the method in accordance with the present invention

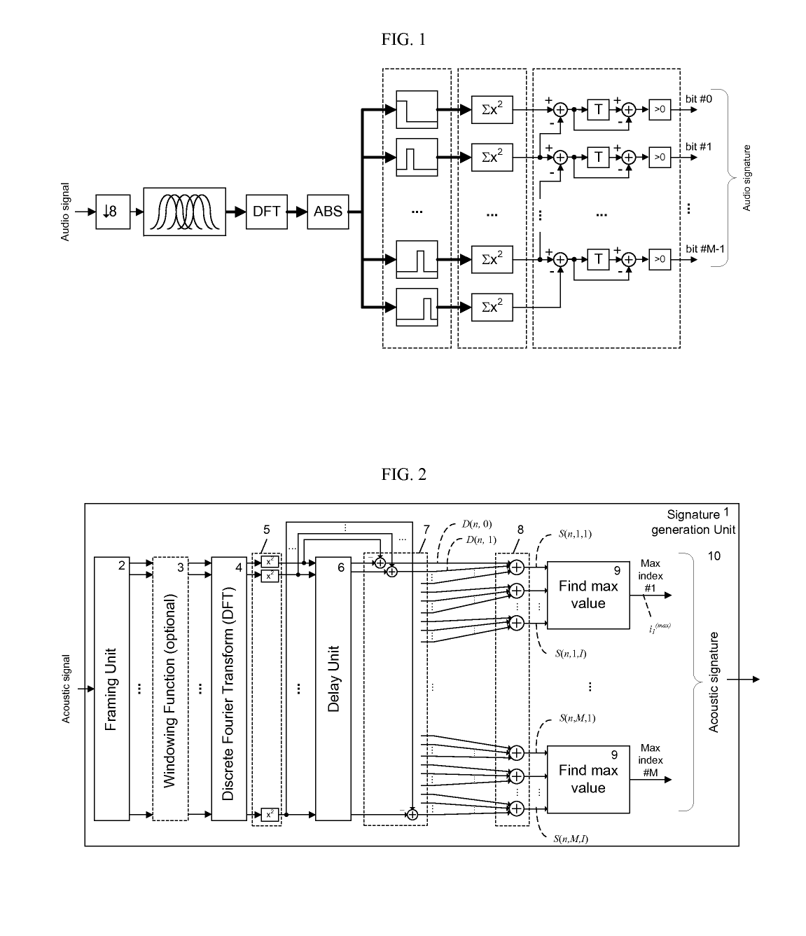

### DETAILED DESCRIPTION OF THE INVENTION

The first three steps in the proposed acoustic signature generation scheme that is dividing into overlapped frames, windowing, and Fourier transformation are fairly common for many types of acoustic signal processing tasks. These pre-processing steps are often used in audio classification, speaker identification, voice recognition and so on. The reason behind this is that the frequency domain representation is very convenient for extracting perceptually important signal features. Some of the perceptually motivated features commonly used to characterize acoustic signals are: spectral flux and spectral centroid and spectral peaks. The spectral flux is calculated as:

$$SF ( n ) = {\sum }_{k = 0}^{K} \vert {F ( n , k )}^{2} - {F ( n - 1 , k )}^{2} \vert$$

where F(n,k) is the Fourier transform output for frame n, and frequency bin k. Spectral flux measures how quickly the power spectrum changes. The spectral flux can be used to determine the timbre of an audio signal. Therefore, the spectral flux is the perceptually motivated feature often used in audio classification algorithms. Another perceptually motivated feature, which can be extracted from FT output is the time-frequency distribution of local spectral peaks, where peak is defined as a local maximum of the magnitude spectrum. Finally, the spectral centroid is a measure of spectral shape:

$$SC ( n ) = \frac{{\sum }_{k = 0}^{K} kF ( n , k )}{{\sum }_{k = 0}^{K} F ( n , k )}$$

Although these features are perceptually motivated and often used in audio classification algorithms they cannot be used directly as audio signatures because (a) they characterize signal in general, and (b) they do not allow compact representation using small number of bits.

In the proposed invention, to achieve the desirable signature properties, the spectral flux is calculated not for entire FT frame, but for local subgroups of frequency bins (steps 4 and 5). The local spectral flux values accurately capture local signal dynamics, but nonetheless they need a lot of bits for storage.

To reduce the amount of bits needed for signature storage. we propose dividing local spectral flux values into several groups and finding the largest local spectral flux value within each group. The positions of local spectral flux peaks in each frame constitute acoustic signature for this frame. It should be noted that such signature derivation is perceptually motivated since the relative positions of the largest local spectral flux values is one of the most psychoacoustically significant sound characteristics.

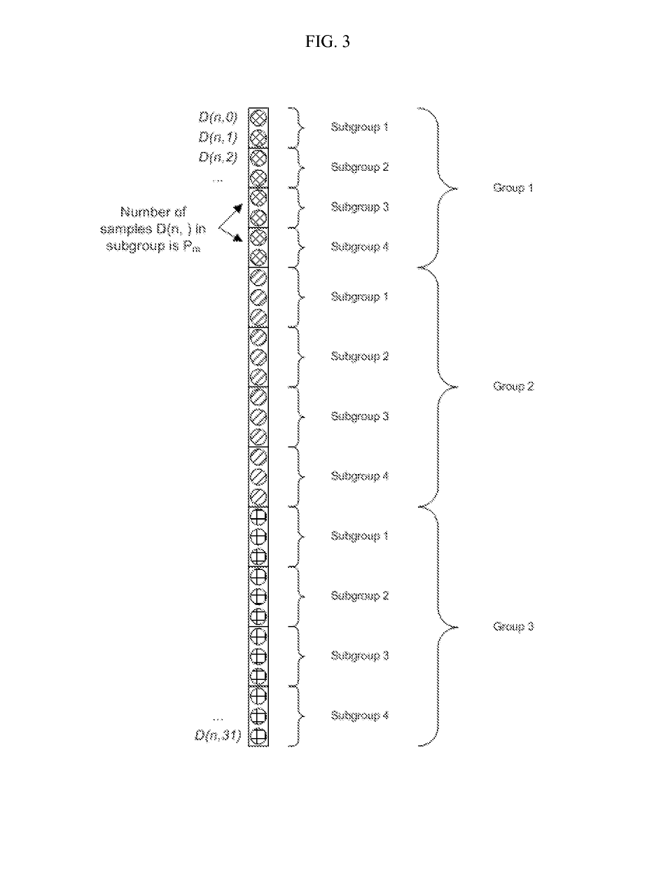

In the preferred embodiment of the invention, it is desirable that the number of subgroups (that is local spectral flux values) in each group be the integer power of two, that is I=2^{p}. where p is a positive integer. In such a case, to represent a single signature index iₘ^{(max)}(n) one would need an optimal (integer) number of bits. The number of samples D(n,k) in each subgroup does not have to be the same, but it is preferred that the number of subgroups per group be the same for all groups. One exemplary group/subgroup arrangement is illustrated in FIG. 3.

We have experimentally discovered that the proposed method with parameters M=8 (number of groups) and I=8 (number of subgroups in each group), in most test cases performs better than known prior art methods, such as one disclosed in U.S. Pat. No. 7,549,052. On the other hand, in the proposed the signature storage requires only N*8*log 2(8)=N*24 bit, versus N*32 bit in [U.S. Pat. No. 7,549,052], that is 25% signature size reduction.

In addition, the proposed method has one more distinct advantage which is especially important for mobile applications. In mobile platforms, the CPU usually lacks a dedicated hardware instruction to count the number of non-zero bits in a word, such as POPCOUNT (consider, for example, a popular ARM architecture). In this case, a POPCOUNT function is usually implemented in software and requires multiple CPU cycles (e.g., at least, ten cycles in ARM architecture). Therefore, this function becomes a major CPU hog for a signature comparison/search on mobile devices. In a prior art methods, which perform bit-by-bit signature comparison, as for example in abovementioned reference, one such function is required for every frame. On the other hand, in the proposed method, only one POPCOUNT function is required per four (4) frames, if the signature sequence is properly pre-formatted. Therefore, the proposed method allows up to 4 times faster direct signature comparison.

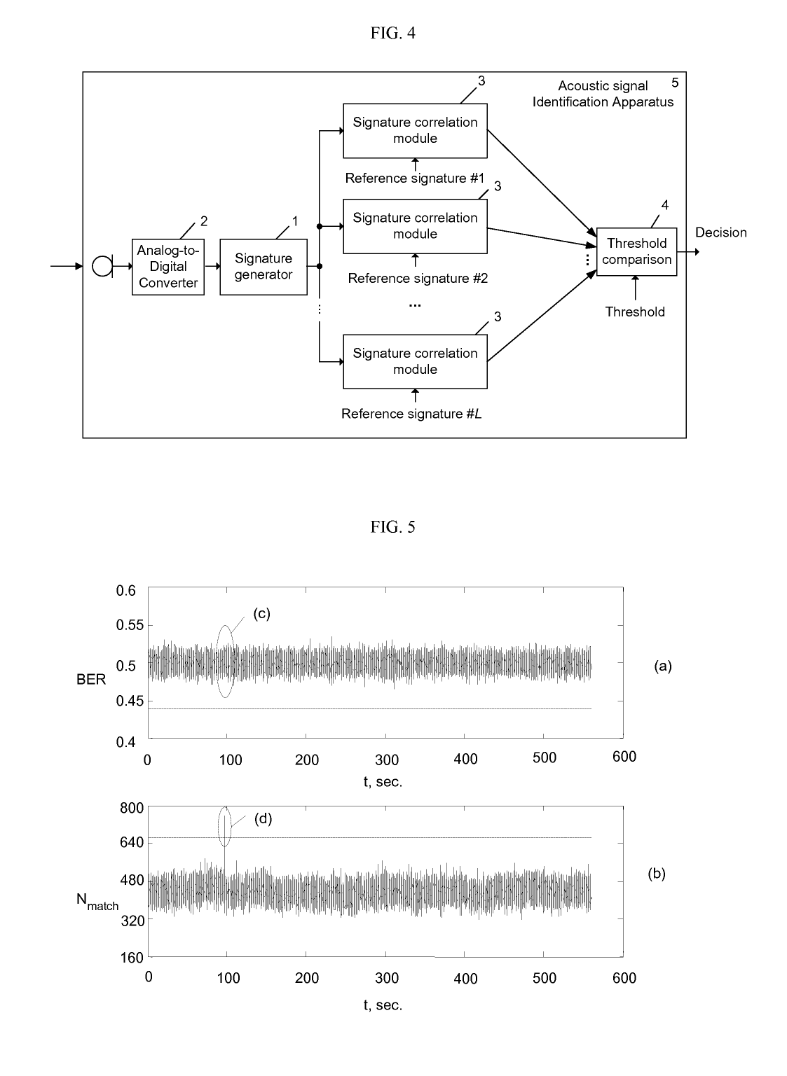

An exemplary embodiment of acoustic signal identification apparatus in accordance with the present invention is illustrated in FIG. 4. In the proposed apparatus, acoustic signatures calculated in signature generation unit 1 are compared with the set of reference signatures #1, . . . , #L, which are pre-computed and stored in device memory. The reference signatures can be fixed or can be updated regularly. The comparison of signatures is performed in L sliding correlators 3. Finally, the sliding correlator outputs are compared with pre-defined threshold in threshold comparison unit 4 and the signal identification decision is made as a result of such comparison.

Performance of the proposed method in comparison with the prior art method is illustrated in FIG. 5. The lower graph in FIG. 5(b), shows the output of one of sliding correlators in the proposed acoustic signal identification scheme. The input acoustic signal contains highly distorted and noisy sample of reference signal at time t=96 sec. The sliding correlator output produces apparent peak above detection threshold (solid line), corresponding to the false identification probability <10⁻⁷ (d). Conversely, the same noisy signal when passed through prior-art signature correlator with the equivalent parameters does not exhibit any evident drop in bit error rate (BER), as seen in FIG. 5(c). Nevertheless, the proposed scheme requires 25% less storage for signatures and allows faster direct signature comparison.

It should be pointed out that the acoustic signature generator and the acoustic signal identification apparatus described hereinbefore constitute just preferred embodiments. As an alternative to the embodiment described hereinbefore, values X(n,k) can be obtained by finding absolute value of k-th Fourier transform bin for n-th frame, instead of finding square value. In another embodiment of the present invention the acoustic signatures can be calculated by finding the minimum value of S(n,m,i) inside each group m=1,2, . . . ,M, such that iₘ^{(min)}=min S (n,m,i).

What is claimed is:

1. An apparatus for generating signature of acoustic signal, comprising:
a) a signal processing unit for dividing an input signal into multiple frames
b) a Fourier transform unit
c) a set of units for converting output of Fourier transform unit into non-negative values
d) a delay buffer unit
e) a set of differentiators for computing difference between non-negative Fourier transform output values for the current frame and non-negative Fourier transform output values for one of previous frames
f) a set of accumulators to sum the differentiated values corresponding to the same subgroup
g) a set of extreme value detection units to detect a subgroup with extreme value in each group

2. An apparatus as claimed in claim 1, further comprising a frame windowing unit positioned in front of a Fourier transform unit

3. An apparatus as claimed in claim 1, wherein the units for converting output of Fourier transform unit into non-negative values are the squaring units

4. An apparatus as claimed in claim 1, wherein the units for converting output of Fourier transform unit into non-negative values are the absolute value units

5. An apparatus as claimed in claim 1, wherein Fourier transform unit performs a fast Fourier transform operation

6. An apparatus as claimed in claim 1, wherein the frame dividing unit divides an input signal into multiple overlapped frames

7. An apparatus as claimed in claim 1, wherein the extreme value detection units are the maximum value detection units

8. An apparatus as claimed in claim 1, wherein the extreme value detection units are the minimum value detection units

9. A system for identifying acoustic signal, comprising:
a) At least one apparatus for computing acoustic signal signatures in accordance with claim 1
b) At least one unit for correlating the computed acoustic signatures with pre-computed and stored signatures

10. A method of generating acoustic signal signatures, comprising the steps of
a) Dividing input signal into multiple frames
b) Computing Fourier transform of each frame
c) Converting Fourier transform output values into non-negative values
d) Computing difference between non-negative Fourier transform output values for the current frame and non-negative Fourier transform output values for one of previous frames
e) Combining said difference values into subgroups
f) Accumulating difference values within a subgroup
g) Combining said accumulated subgroup values into groups
h) Finding an extreme accumulated value within each group

11. A method as claimed in claim 10, further comprising the step of applying a windowing function to a signal frame before the step of computing Fourier transform

12. A method as claimed in claim 10, wherein converting Fourier transform output values into non-negative values is performed by means of squaring, function

13. A method as claimed in claim 10, wherein converting Fourier transform output values into non-negative values is performed by means of absolute function

14. A method as claimed in claim 10, wherein computation of Fourier transform is performed by means of fast Fourier Transform method

15. A method as claimed in claim 10, wherein an input signal is divided into multiple overlapped frames

16. A method as claimed in claim 10, wherein, the step of finding an extreme accumulated value within each group is a step of finding a maximum accumulated value within each group

17. A method as claimed in claim 10, wherein, the step of finding an extreme accumulated value within each group is a step of finding a minimum accumulated value within each group
